(19) United States
(12) Patent Application Publication
(10) Pub. No.: US 2008/0269982 A1
(43) Pub. Date: Oct. 30, 2008

(54) Fault Validation Method and System for Aerodynes

(75) Inventors: Carine Bailly, Tournefeuille (FR); Christian Albouy, Villemur-Sur-Tarn (FR); Francois Fournier, Roques Sur Garonne (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/067,359

(22) PCT Filed: Sep. 18, 2006
(86) PCT No.: PCT/EP2006/066468

§ 371 Date: Jul. 9, 2008

(30) Foreign Application Priority Data
Sep. 23, 2005 (FR) 05 09779

(51) Int. Cl. G06F 17/30; G01M 17/007

(52) U.S. Cl. 701/35

(57) ABSTRACT

The present invention relates to a fault validation method and system for aerodynes. The method includes at least a configuration step associating with each detectable fault equipment units for which a copy of memory segments is to be made. Verification tests to be performed include a step for copying memory segments and a step for verifying equipment units.

### CROSS-REFERENCE TO RELATED APPLICATIONS

The present Application is based on International Application No. PCT/EP2006/0066468, filed on Sep. 18, 2006, which in turn corresponds to French Application No. 05 09779, filed on Sep. 23, 2005, and priority is hereby claimed under 35 USC §119 based on these applications. Each of these applications are hereby incorporated by reference in their entirety into the present application.

### FIELD OF THE INVENTION

The present invention relates to a fault validation method and system for aerodynes. It applies, for example, to the field of avionics.

### BACKGROUND OF THE INVENTION

Airplane maintenance is a continuous process which is not limited to a few periodic inspections for complete verification. Throughout the operation of a craft, the latter is under constant surveillance. Initially, the onboard mechanics receive alarms in flight that they analyze instantaneously and that they report in the aircraft engine logbook of the airplane. Then, the maintenance technicians on the ground collect, after each flight, the failure or malfunction data generated during the flight. This data has been generated either automatically by avionics equipment units or manually by the crew.

After each landing and before any new take-off, even if it is a simple stopover, the airplane is subjected to an airport maintenance procedure. All the traces of events characterizing a failure or an abnormal operation of one of the equipment units of the airplane during the last flight are recovered, analyzed and interpreted in order to create a diagnostic report as to the capability of the airplane to take off and make a new flight in satisfactory safety conditions. To create this diagnostic report, the operator has a number of sources of information on the failures, these sources being of non-uniform types. First of all, he reads the aircraft engine logbook kept by the pilot which summarizes in particular all the events associated with a malfunction and that had a cockpit effect, that is, that are reflected by an alarm, whether audible or visual, intended for the cockpit. Some malfunctions are considered superficial because they have no impact on safety, and consequently they are not the subject of an alarm to the pilot. The aircraft engine logbook is therefore incomplete from the point of view of failures. Then, the operator reads a report commonly designated “Post Flight Report” (hereinafter called PFR) which summarizes the failure or abnormal operation messages generated by avionics equipment units. The PFR is automatically generated by a dedicated hardware and software module designated “Centralized Maintenance System” (hereinafter called CMS). The maintenance operator can output on screen or print out the PFR depending on his requirements. It is a textual document that can be read by those skilled in the art having sufficient knowledge of the maintenance operations and having the maintenance guide of the craft available. The PFR implicates equipment units that are designated “Line Replaceable Units” (hereinafter called LRU) which can be hardware and software modules in the form of computer-type plug-in modules or even sensors, or even actuators, that the operator can easily change if necessary. These LRUs include a maintenance function of a type known by its designation “Built-In Test Equipment” (hereinafter called BITE function). This BITE function enables the LRUs to make copies of memory segments, to run diagnostics on their internal operating state and issue reports that are by extension called BITE messages. These messages contain, among other things, the identifier of the implicated LRU, a failure code and a time the fault occurred. It is these BITE messages that have been sent by the LRUs to the CMS, the CMS having stored them and used them to generate the PFR. The PFR often implicates a large number of LRUs, but all the implicated LRUs are often not defective. In practice, it is “cascaded” LRU failures or malfunctions that are being witnessed, in which it is the abnormal behavior of a single LRU that provokes abnormal messages concerning other LRUs that are operating normally, the latter generating the same messages as the defective LRU for example. And this is precisely the essential nature of the problem, because if the operator follows the content of the PFR to the letter, he will send equipment units without defects and operating correctly for repair.

One solution usually implemented with a view to isolating the origin of the failure and establishing a more accurate diagnostic report is purely manual. It involves, for the maintenance operator, running successive tests and recovering the results and the copies of memory segments that will confirm or deny the implication of each LRU in the PFR. First of all, to determine the LRUs to be tested initially, the operator tries to imagine the cockpit effects of the malfunction of each LRU implicated in the PFR. If this effect is reported at the same time in the aircraft engine logbook as the fault of the LRU in the PFR, then he starts the test procedure associated with this LRU. The operator relies entirely on the maintenance guide of the craft to conduct this procedure correctly and above all to determine the sequencing of the LRU test steps according to the results obtained. This guide tells him, step by step, the tests to be run. Thus, based on the PFR generated by the CMS, from the cockpit effects reported by the pilot in the aircraft engine logbook and from the maintenance guide of the craft, the operator has to obtain a restricted list of LRUs in an actual failure or malfunction state. Depending on the status of each of these LRUs with regard to flight safety, a status commonly qualified by the expressions “GO” and “NO GO”, based on the recommendations of the maintenance guide and also the experience of the operator, the latter proceeds to replace the LRUs before the airplane takes off again. In some cases this can lead to the immobilization of the craft, particularly as a result of unavailability of replacement LRUs or on recommendation from the maintenance guide.

A first major drawback of this solution is the time involved in executing it. In practice, the PFR is an exhaustive report but by the same token it is not clearly understandable. The aircraft engine logbook that has to be correlated with the PFR is not only incomplete but nor is it dedicated or even truly maintenance oriented and therefore takes a certain time to be interpreted correctly. And finally, the maintenance guide represents a very large quantity of information that is difficult to handle. Furthermore, each test step and the recovery of copies of memory segments often takes several minutes. Now, the cost-effectiveness context in which these operations are carried out must be taken into account. For example stopovers must not exceed a certain duration to maximize the cost effectiveness of the craft and the airport facilities. Consequently, in many cases, the operator will prefer to change LRUs if he does not have the time to work through the tests to the end and the repair services then receive non-defective LRUs. Thus, this solution presents major economic drawbacks, whether from the point of view of the airline owning the airplane or from the point of view of the company operating the airport, or even from the point of view of the contractor providing the workshop maintenance services for the equipment units.

Another major drawback of this solution is that the amount of assessment left to the operator in this economic pressure context is a potential source of errors which means that there is a risk of airplanes taking off again with defective LRUs. This lack of reliability of the diagnostic is a serious threat to flight safety. Thus, this solution also presents a major drawback from the point of view of the passengers.

### SUMMARY OF THE INVENTION

A main aim of the invention is to save operator time in certain maintenance tasks, thus enabling the operator to focus more closely and more calmly on the more difficult operations requiring real expertise. To this end, the subject of the invention is a fault validation method and system for aerodynes. The method comprises at least a configuration step associating with each detectable fault on the one hand equipment units for which a copy of memory segments is to be made and on the other hand verification tests to be performed, a step for copying memory segments and a step for verifying equipment units.

Advantageously, the associations defined during the configuration phase can be modeled in the form of a matrix with i rows and (m+n) columns, where i, m and n are non-zero integers, i being the number of known distinct faults, m being the maximum number of equipment units for which a memory copy can be made, n being the maximum number of verification tests that can be performed.

For example, the detected faults are BITE maintenance messages generated by avionics equipment units.

Other main advantages of the invention are that it can be performed automatically immediately after landing, thus freeing the ground maintenance operator of operations involving running certain tests and recovering results. The time saving that results from this helps toward a better cost effectiveness. Furthermore, the invention can be implemented on the most conventional avionics architectures without changing the hardware configuration.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein

FIG. 1, a block diagram of the successive steps of the method according to the invention;

FIG. 2, a diagram of an exemplary hardware and software architecture implementing a system according to the invention.

### DETAILED DESCRIPTION OF THE DRAWINGS

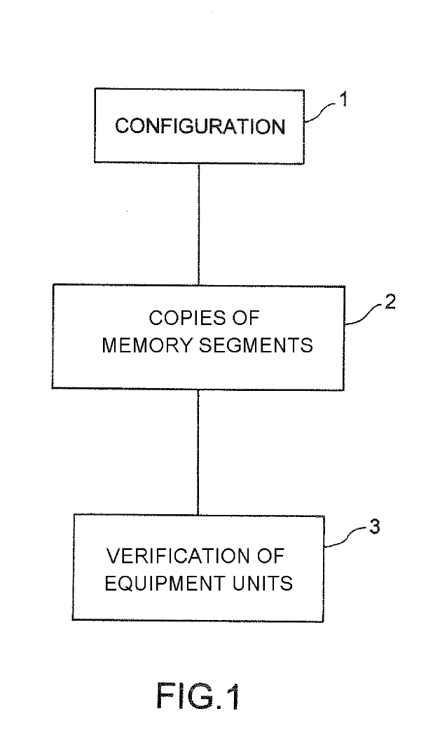

FIG. 1 is a block diagram illustrating the successive steps of the method according to the invention.

It firstly comprises a configuration phase 1. This phase is a phase for defining the data used by the method that depends on the avionics system. It is performed initially before the avionics system is operated, before a failure or a malfunction can occur. It provides a way of associating with each event characteristic of a fault, on the one hand equipment units for which a copy of the memory is relevant and on the other hand relevant verification tests. All this association data will be useful in the subsequent phases of the method described below. It is stored for this purpose.

A step 2 for copying memory segments of certain equipment units is initiated on the occurrence of an event characteristic of a fault, the copy being commonly designated, in information technology, a “dump”. The equipment units concerned are those that are definitely or potentially involved directly or indirectly in the fault, this having been deduced from an in-depth knowledge of the architecture of the avionics system. For example, an event characteristic of a fault can be the output by an avionics equipment unit of a BITE message. The memory segment copies are stored for the benefit of the maintenance operator.

Finally, a step 3 for verifying equipment units is initiated. The aim of this is to confirm or deny the malfunction of the equipment units originating the events characteristic of a fault, by running test procedures. In practice, as explained previously in the case where the equipment units are LRUs, it can be a “cascaded” malfunction phenomenon and an equipment unit may give signs of fault without actually having failed. For example, the tests can be independent tests of the LRUs made available by their BITE function. On completion of the test the equipment unit can supply details as to its internal operating state. The results of the tests are, for example, stored for the benefit of the maintenance operator.

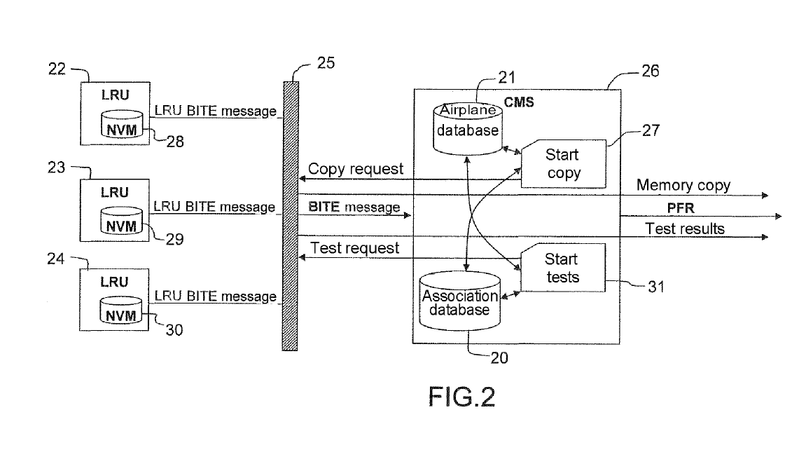

FIG. 2 is a diagram illustrating an exemplary hardware and software architecture implementing a system according to the invention. In this embodiment, a database 20, called association database, stores in particular a configuration matrix. The configuration matrix contains the associations between the faults, the equipment units for which a memory copy must be made and the verification tests to be performed. For example, it is a matrix with i rows and (m+n) columns with i, m and n being non-zero positive integers. The i rows are used to represent the i events characteristic of known faults at the time of implementation of the system. For a given row i corresponding to an event characteristic of a fault, the first m columns are used to associate with it a maximum of m equipment units for which a memory copy must be made and the subsequent n columns are used to associate with it a maximum of n verification tests to be performed. The operations are to be performed in ascending order of the column indices, this order reflecting, for example, the chronological sequence described in the maintenance guide. In this embodiment, a database 21, called airplane database, stores a modeling of the hardware and software architecture of the avionics equipment units of the craft. It stores in particular the details of the interrogation mode of the equipment units, for example, the address of the equipment units on the data bus 25 which will make it possible to send them requests concerning their state in cases where a fault is detected. This airplane database is populated once and for all on installation of the avionics equipment units in the airplane. It can, if necessary, be updated if the avionics system is modified during the life of the craft. The two databases are part of a CMS-type subsystem 26, the purpose of which, as explained previously, is to supply PFRs. In the example illustrated by FIG. 2, the configuration data is stored in databases, but it can equally be loaded into the random-access memory of a computer of the CMS, which improves the data access times.

In this example, the avionics equipment units that can supply failure or malfunction messages are the three LRUs 22, 23 and 24. These LRUs include a BITE function described previously which enables the LRUs to output BITE messages containing, among other things, an identifier of the implicated LRU, a failure code and a time the fault occurred. The BITE functions of the LRUs of this example each comprise a hardware module for storing memory segments designated “non-volatile memory” (hereinafter called NVM). It is the NVMs 28, 29 and 30 that enable the LRUs to make copies of their memory on detection of a malfunction at the same time as they output a BITE message. In the example of the figure, the LRUs are connected to the same data bus 25 to which the CMS is also connected. For any BITE message output by one of the LRUs and received by the CMS, the memory copy phase for the failed equipment units of the method according to the invention is triggered by the activation of a function 27 for initiating a copy. In this embodiment, the copy initiating function advantageously establishes the association between the received BITE message and the equipment units for which a copy of the memory must be made, by analyzing the first m columns of the row j of the configuration matrix corresponding to the received BITE message. It also uses the details of the interrogation modes of the equipment units described in the airplane database, such as their address on the data bus, to send memory copy requests targeting each of the potentially implicated equipment units, namely the LRUs. The copies of relevant memory segments contained in the NVMs are sent in response to the copy requests sent by the copy initiating function. The memory segment copies cannot be read by a man and are therefore not included in the PFR which remains unchanged. They are made available to the maintenance operator as such by the CMS. The CMS, which is a totally maintenance-oriented system, provides the maintenance operator with a way of recovering memory segment copies that is far better in terms of bit rate than that provided directly by the avionics equipment unit. Thus, the maintenance operator downloads voluminous memory copies in a considerably shorter time.

Then, the function 31 for running the verification tests analyzes the last n columns corresponding to row j of the configuration matrix to ascertain which equipment units are to be tested. It also uses the details of the interrogation modes of the equipment units described in the airplane database, such as their address on the data bus, to send test requests targeting each of the potentially implicated LRUs. In this embodiment, the tests run are independent tests made available by the BITE function of the LRUs. The results returned by the BITE function of the LRUs are not included in the PFR which remains unchanged, but are made available to the maintenance operator in the raw state and according to a standard recovery mode also known to the operator. However, it could be envisaged for the CMS to make a summary in the PFR that it sends in addition. In any case, the maintenance operator directly downloads the results of the tests; he no longer has to wait for them to be executed.

The LRUs of this example do not operate in mixed mode, that is, both in operational mode and in maintenance mode, the functions for initiating copies and for initiating tests are not executed in flight on receipt of a BITE message. They are executed only immediately after landing and after switching the LRUs to maintenance mode. The LRUs are switched to maintenance mode automatically, for example by analyzing the status commonly designated “Weight On Wheels” which indicates whether one of the wheels of the airplane is supporting weight or not. Thus, all that now remains for the ground maintenance operator is to consult the PFR, knowing that the memory copies and the test results of the LRUs implicated in this PFR will already be available without any manual intervention on his part. This is the key point of the inventive method, namely the automation of certain maintenance tasks with a view to saving on craft and airport facilities operating times. It is even possible to envisage having the PFR, the memory copies and the test results sent to the maintenance operator before he leaves his workshop. Thus, he can procure the potentially failed LRUs before going to the airplane on the tarmac.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A fault validation method for aerodynes,
a configuration step associating with each detectable fault for which a copy of memory segments is to be made and verification tests to be performed, the associations defined during the configuration being modeled in the form of a matrix with i rows and (m+n) columns, where i, m and n are non-zero integers, i being the number of known distinct faults, m being the maximum number of equipment units for which a memory copy can be made, n being the maximum number of verification tests that can be performed;
a step for copying memory segments;
a step for verifying equipment units.

2. The fault validation method for aerodynes as claimed in claim 1, wherein the detected faults are BITE maintenance messages generated by avionics equipment units.

3. A fault validation system for aerodynes, comprising:
a data storage device associating with each detectable fault equipment units for which a copy of memory segments is to be made and verification tests are to be performed, the association with each detectable fault of the equipment units for which a copy of memory segments is to be made and verification tests are to be performed being stored in the form of a matrix with i rows and (m+n) columns, where i, m and n are non-zero integers, i being the number of known distinct faults, m being the maximum number of equipment units for which a memory copy can be made, n being the maximum number of verification tests that can be performed;
a module for copying memory segments; and
a module for verifying equipment units.
